(19) United States
(12) Patent Application Publication
(10) Pub. No.: US 2012/0303475 A1
(43) Pub. Date: Nov. 29, 2012

(54) PROVIDING QUOTES FOR FITNESS EQUIPMENT

(76) Inventor: John Thomas Sarver, Indianapolis, IN (US)

(21) Appl. No.: 13/480,206

(22) Filed: May 24, 2012

Related U.S. Application Data
(60) Provisional application No. 61/489,579, filed on May 24, 2011.

(51) Int. Cl. G06Q 30/00

(52) U.S. Cl. 705/26.4

(57) ABSTRACT

Disclosed are various embodiments for providing quotes for fitness equipment. A selection of a property type, a number of property units, and a specification of a fitness room size are obtained from a user. A first user interface is generated for obtaining a selection of fitness equipment from the user. The selection of fitness equipment is obtained from the user via the first user interface. A quote is automatically generated for providing fitness equipment to the user. The quote is based at least in part on the selection of fitness equipment, the fitness room size, the number of property units, and the property type. A second user interface is generated for presenting the quote.

### CROSS-REFERENCE TO RELATED APPLICATION

This application claims priority to, and the benefit of, U.S. Provisional Patent Application entitled, “PROVIDING QUOTES FOR FITNESS EQUIPMENT,” having application No. 61/489,579, filed on May 24, 2011, which is incorporated by reference in its entirety.

### BACKGROUND

It is common that hotels, motels, resorts, assisted living facilities, corporate centers, apartment complexes, condominiums, and other properties have rooms available for their customers/occupants to use fitness equipment. Different types of fitness equipment may be employed at different properties. Some properties may devote relatively more space to fitness equipment than other properties.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2-8 are drawings of examples of user interfaces rendered by a client in the networked environment of FIG. 1 according to various embodiments of the present disclosure.

FIG. 9 is a flowchart illustrating one example of functionality implemented as portions of a quote generation application executed in a computing device in the networked environment of FIG. 1 according to various embodiments of the present disclosure.

FIG. 10 is a schematic block diagram that provides one example illustration of a computing device employed in the networked environment of FIG. 1 according to various embodiments of the present disclosure.

### DETAILED DESCRIPTION

The present disclosure relates to generating and providing quotes for fitness equipment for various establishments. The proprietors or managers of various facilities often select packages of fitness equipment that will meet their needs. Different facilities may have different requirements. For example, a luxury hotel may require higher end fitness equipment than an economy hotel. As another example, a hotel may require more durable fitness equipment than an assisted living facility, because the occupants at the assisted living facility are not likely to use the fitness equipment as often. It is also important to have the correct amount or configuration of fitness equipment given the size of the facility and expected usage. In addition, health clubs, government facilities, and/or other vertical markets for fitness equipment may have needs for new fitness rooms and/or replacement equipment. Such health clubs, government facilities, and so on may also have established requirements or specifications for fitness equipment.

Various embodiments of the present disclosure provide a client/server architecture for providing information about a property and its requirements and generating one or more quotes for fitness equipment specially tailored for the facility. In one embodiment, the form or forms for the user to provide information may begin on the home page of a website. By placing the form on the home page of the website, the form is more visible and may induce more users into obtaining quotes electronically. Having selective criteria on the home page may provide a more interactive and progressive user experience.

The network-based architecture employed for various embodiments facilitate obtaining information from users any time and at any location without tying up sales or administrative personnel in asking the user questions and/or comparing their answers to requirements in order to generate quotes. Although the discussion herein primarily relates to fitness equipment, it is understood that the principles of the present disclosure may be applied to quotes for furniture or other equipment that may be provided in a room or other area for a particular property. In the following discussion, a general description of the system and its components is provided, followed by a discussion of the operation of the same.

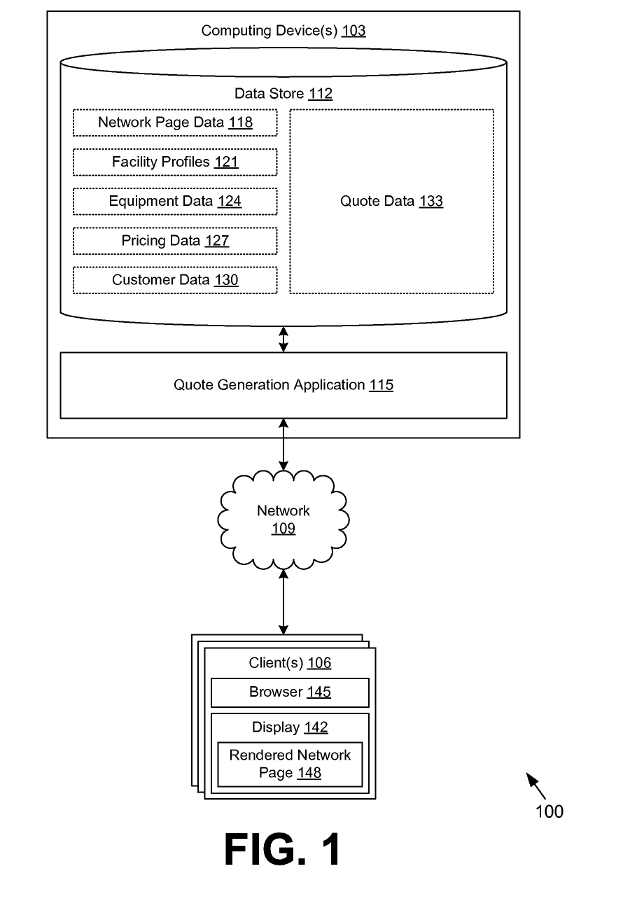

With reference to FIG. 1, shown is a networked environment 100 according to various embodiments. The networked environment 100 includes one or more computing devices 103 in data communication with one or more clients 106 over a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device 103 is referred to in the singular, it is understood that a plurality of computing devices 103 may be employed in the various arrangements as described above.

Various applications and/or other functionality may be executed in the computing device 103 according to various embodiments. Also, various data is stored in a data store 112 that is accessible to the computing device 103. The data store 112 may be representative of a plurality of data stores 112 as can be appreciated. The data stored in the data store 112, for example, is associated with the operation of the various applications and/or functional entities described below.

The components executed on the computing device 103, for example, include a quote generation application 115, and other applications, services, processes, systems, engines, or functionality not discussed in detail herein. The quote generation application 115 is executed to obtain information from customers over the network 109, process the information in accordance to stored requirements and/or other store logic, and generate one or more quotes for fitness equipment configured to meet the needs of the user. To this end, the quote generation application 115 may include a network page server that is commercially available such as, for example, APACHE HTTP Server, MICROSOFT Internet Information Services (IIS), APACHE TOMCAT, and/or other servers. The quote generation application 115 may be configured to generate one or more network pages, such as web pages, or other forms of network content to be sent to the client 106.

The data stored in the data store 112 includes, for example, network page data 118, facility profiles 121, equipment data 124, pricing data 127, customer data 130, quote data 133, and potentially other data. The network page data 118 may include various forms of data related to generating network pages by the quote generation application 115. For example, the network page data 118 may include, but is not limited to, text, code, templates, images, graphics, multimedia, and/or other data used for generating network pages. The facility profiles 121 include various data relating to requirements of various types of facilities. Such facility profiles 121 may be generic for certain types of facilities, such as assisted living homes, corporate centers, or other generic types of facilities. Alternatively, the facility profiles 121 may be specific to certain brands or chains for facilities such as hotels chains, apartment operators, and so on.

The equipment data 124 includes various data relating to fitness equipment or other equipment that may be placed in a fitness facility with in a logging or other type of facility. Such equipment may include, for example, cardio equipment, multi functions strength stations, abdominal benches, weight machines, free weights, and/or other types of fitness equipment. The equipment data 124 may include, for example, information relating to dimensions of equipment, durability of equipment, expected use of equipment, popularity of equipment among various demographics, and/or other information.

The pricing data 127 includes data relating to cost and/or retail pricing for various types of equipment or systems of equipment. The pricing data 127 may be employed in generating quotes for customers as to how much a particular configuration of this equipment would cost. The pricing data 127 may include various heuristics regarding applied discounts for certain combinations of fitness equipment, base costs for the various types of equipment, desired markup for the equipment, installation costs, freight costs, and/or any other information relating to price that may be used in generating a quote by the quote generation application 115.

The customer data 130 may include various information relating to customers. Such a customer may be a new customer or an existing customer of the system. In one embodiment, customer data 130 includes information regarding a facility with property managed by the customer, affiliations of the facility, fitness room size, number of units or guest rooms, contact information, billing information, fitness equipment information and/or any other information relating to customers. The quote data 133 includes data relating to quotes generated by the system and/or quotes that are in the process of being generated by the quote generation application 115.

The client 106 is representative of a plurality of client devices that may be coupled to the network 109. The client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 106 may include a display 142. The display 142 may comprise, for example, one or more devices such as cathode ray tubes (CRTs), liquid crystal display (LCD) screens, gas plasma-based flat panel displays, LCD projectors, or other types of display devices, etc.

The client 106 may be configured to execute various applications such as a browser 145 and/or other applications. The browser 145 may be executed in a client 106, for example, to access and render network pages, such as web pages, or other network content served up by the computing device 103 and/or other servers, thereby generating a rendered network page 148 on the display 142. The client 106 may be configured to execute applications beyond browser 145 such as, for example, email applications, instant message applications, and/or other applications.

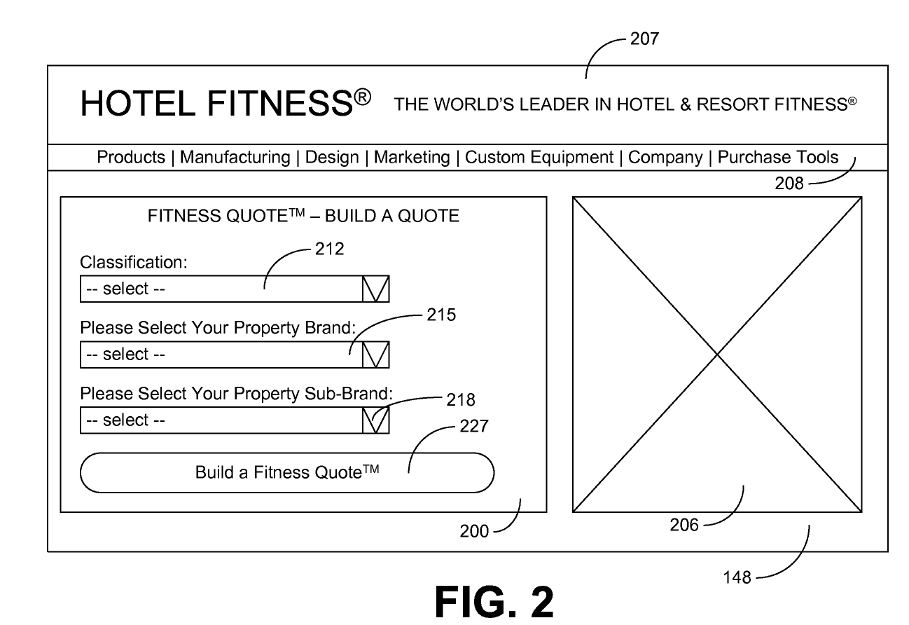

Next, a general description of the operation of the various components of the networked environment 100 is provided. To begin, a customer navigates to the network site served up with the quote generation application 115. For example, a user may request the homepage of the network site. In response the quote generation application 115 generates a network page to obtain data. The network pages are sent across the network 109 to the client 106 and in particular to the browser 145 executed in the client 106. With the network page, the browser 145 generates a rendered network page 148 on the display 142. Through the rendered network page 148, the quote generation application 115 leads the user through a series of forms to provide information to be used in generating the quote. Ultimately, a quote is presented to the user and may be submitted for further follow up by sales personnel and/or other personnel. The series of forms/user interfaces is described in connection with FIGS. 2-8.

Referring next to FIG. 2, shown is one example of a rendered network page 148 rendered in a browser 145 (FIG. 1) executed in a client 106 (FIG. 1) in the networked environment 100 (FIG. 1). The rendered network page 148 corresponds to a home page of a website. In the rendered network page 148, a user interface 200 is rendered to the left of a graphic or picture 206 on a homepage of a website. The user interface 200 may be included on the homepage to increase participation with respect to the user interface 200. The user interface 200 is rendered below a banner 207 and a header menu 208 in this example. It is understood that the rendered network page 148 is merely one example illustration of a layout for the user interface 200 and many other different layouts may be employed in other embodiments as appreciated. In some cases, the user interface 200 may be included on a mobile application screen or on other web pages that are not the homepage of a web site.

In some examples, the user interface 200 may include a property search box. In such a property search box, the customer may enter a query for a property type. In one embodiment, the property search box may employ an auto complete feature for lodging types or other properties that match the query. The property type search box may be used to load various default information relating to a specific property type. In this way, data entry for the customer may be simplified.

The user interface 200 may include a property type selection tool 212. The property type selection tool 212 may facilitate a specification of a type of property to be used in generating a quote for an equipment package of fitness equipment for the type of property. As shown, the property type selection tool 212 may comprise a drop-down box or scroll-down box. However, it is understood, in other embodiments, the property type selection tool 212 may employ other types of user interface components such as, for example, a set of radio buttons, sliders, check boxes, and/or other types of user interface components.

In this non-limiting example, the property type selection tool 212 enables the customer to select from options such as, for example, economy hotel, full service hotel, luxury hotel, boutique hotel, hotel, country club, resort, assisted living, corporate center, apartment complex, condominium, multi-family and other types of properties. Once a customer selects a specific property type using the property type selection tool 212, the quote generation application 115 (FIG. 1) may be prepared to populate other data in the form or configure various types of input fields of the form in the user interface 200 to gather other information. The property type selected using the property type selection tool 212 may be employed to determine various requirements for fitness equipment, pricing structures, and/or other information used by the quote generation application 115 in generating a quote. It is noted that the quote generation application 115 may correlate the property type with a facility profile 121 (FIG. 1) in order to determine quality of equipment, which may vary based on equipment type or manufacturer. For example, a fitness room in an assisted living facility may be seldom used in comparison to a fitness room in a luxury hotel. Thus, it may be acceptable to use lesser grade equipment in the assisted living facility to save expense.

A property brand selection tool 215 may be provided for the customer to select a specific property brand for the quote. Although some property types may not be associated with brands, other property types may be associated with brands. For example, a hotel may be associated with a brand. It may be the case that the property brand selection tool 215 depends upon a selection of a property type using the property type selection tool 212. For example, when a customer selects a property type using the property type selection tool 212, a list of appropriate brands may be populated with in the property brand selection tool 215. The brands may, for example, include pseudo-brands such as “independent,” “other,” etc. as desired.

Although the property brand selection tool 215 is shown in the user interface 200 as being a drop down box, it is understood that the property brand selection tool 215 may comprise radio buttons, check boxes, sliders, and/or other types of user interface components in other embodiments. As a non-limiting example, the customer may select economy hotel under the property type selection tool 212 and, accordingly, the various property brands appropriate to the economy hotel property type may be populated within the property brand selection tool 215. In some cases, the property brand selection tool 215 may be absent, grayed out, unpopulated, etc. if it is not applicable to the current selection in the property type selection tool 212.

As shown in FIG. 2, a property sub brand selection tool 218 may also be included. In some cases, a property brand selectable under a property brand selection tool 215 may have various types of sub brands. In one non-limiting example, the brand WYNDHAM may be selected using the property brand selection tool 215. Accordingly, a list of sub brands appropriate to the WYNDHAM brand may be populated within the property sub brand selection tool 218. For example, in the property sub brand selection tool 218 PLANET HOLLYWOOD and DREAM HOTELS may be shown.

Although the property sub brand selection tool 218 is depicted as a drop down box, it is understood that in other embodiments, sliders, check boxes, radio buttons, buttons, and/or other types of user interface components may be employed. In some embodiments, multiple levels of property sub brands may be selected. For example, a tree-driven structure may be used to select a specific brand with in a hierarchy of brands. The quote generation application 115 may use requirements and/or other data from the facility profiles 121 identified with a property type/brand/sub-brand in determining the quality or quantity of the fitness equipment for the quote.

Also, in other embodiments, the property sub brand selection tool 218 may be absent. While hotels and other property types may have sub-brands, still other property types may not have sub-brands. Some property types may have sub-brands and others may not depending at least in part on the property type and/or brands. In some cases, the property sub brand selection tool 218 may be absent, grayed out, unpopulated, etc. if it is not applicable to the current selection in the property brand selection tool 215.

An input submission tool 227 may be provided for the user to submit the various data provided by the user through the user interface 200. When the input submission tool 227 is submitted, the data may be sent from the browser 145 to the quote generation application 115 by way of the network 109. Other submission tools may be employed in other embodiments.

In one embodiment, the selection of data in the user interface 200 begins the process of the quote generation application 115 in narrowing down product lines, manufacturers, etc. for the quote. For example, a particular brand may require equipment having a user capacity of a particular weight. Selection of that particular brand therefore excludes equipment not meeting the user capacity of the particular weight. Other standards or requirements of brands, sub brands, and property types may also be used as filters for equipment.

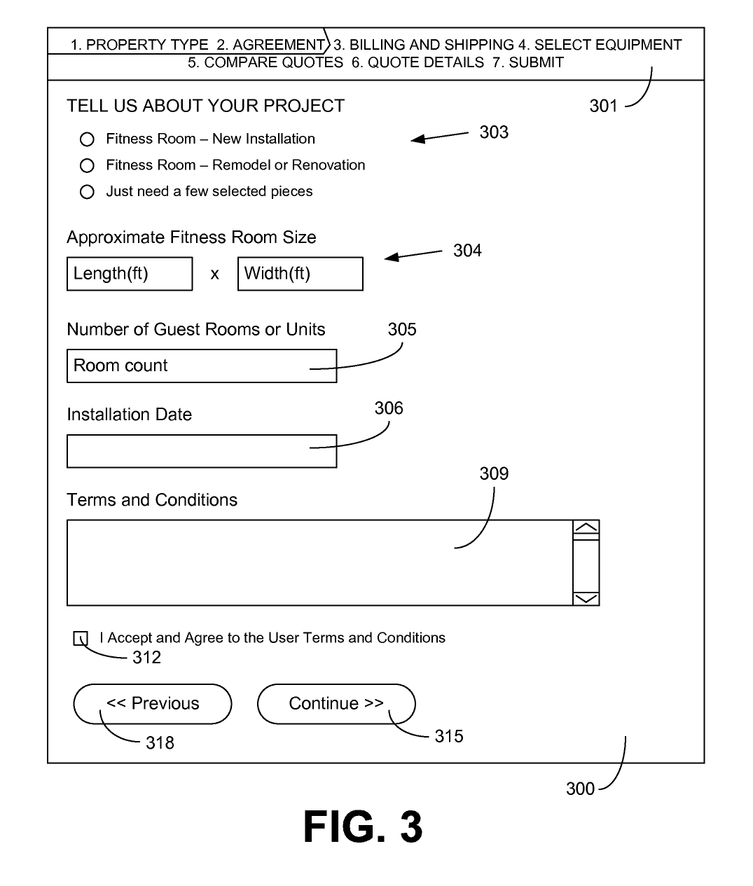

Continuing on to FIG. 3, shown is one example of a user interface 300 rendered by a browser 145 (FIG. 1) executed in the client 106 (FIG. 1) in the networked environment 100 (FIG. 1). A status indicator 301 indicates that the “1. PROPERTY TYPE” task has been completed, and that the current task is “2. AGREEMENT.” The tasks indicated in the status indicator 301 are provided merely as a non-limiting example of providing task completion information to the customer. In some cases, one or more tasks may be selectable for navigational purposes.

After the customer completes the form of the user interface 200 (FIG. 2), the customer is given an opportunity to provide more information about its project. To this end, a project type selection tool 303 is provided. The project type selection tool 303 allows the customer to select from various project options, such as purchasing fitness equipment for a new fitness room installation, purchasing fitness equipment for a remodeling of an existing fitness room, purchasing replacement equipment for an existing fitness room, and/or other options.

The type of project that is selected using the project type selection tool 303 may affect the computation of a quote. As a non-limiting example, it may be more costly to install a new fitness room because of restrictions on when it may be installed during the construction process for the property. The project type selection tool 303 is shown in FIG. 3 as comprising radio buttons. However, in other embodiments, the project type selection tool 303 may include other interface components such as, for example, check boxes, sliders, buttons, or other types of user interface components.

A fitness room size specification tool 304 may be provided for the customer to specify an approximate size for the fitness room of the property. The default text as shown may be “Length(ft)” and “Width(ft).” In one embodiment, the default text may disappear when the respective boxes are selected. As shown in this example, the customer may specify a length in feet and a width in feet. In other embodiments, the metric system may be employed as well as other types of inputs.

For example, the area of the room in square feet may be specified by the user. With the fitness room size specification tool 304, the area of the fitness room may be dynamically calculated based upon the length and the width. For example, it may be populated that a room size of a certain number of square feet may allow for approximately a determined number of pieces of equipment. The number of pieces of equipment may be based upon an empirical formula determined by the operator of the system. In various embodiments, a factor ranging from 1.25 to a factor of 1.5 pieces of fitness equipment per 100 square feet may be employed. In other embodiments, other factors may be employed as appropriate. The empirical formula may take into account standards, laws, and regulations, such as those promulgated by the Americans with Disabilities Act and elsewhere.

A unit specification box 305 may be provided for the customer to enter a number of guest rooms or units associated with their property. The default text as shown may be “Room count.” In one embodiment, the default text may disappear when the unit specification box 305 is selected. The unit specification box 305 is used to obtain a value as employed by the quote generation application 115 (FIG. 1) to select a proper quality of the equipment. An empirical formula is employed based on industry experience relating to the various property types and numbers of units. For example, a relatively large property may need a relatively high quality of fitness equipment because the fitness equipment will see greater use. Although the unit specification box 305 is shown as a text input box, other user interface components may be employed in other embodiments such as sliders, drop down boxes, and/or other types of input components. In some embodiments, the unit specification box 305 and/or the fitness room size specification tool 304 may be included instead in the user interface 200.

An installation data specification tool 306 may be provided to allow the customer to specify a desired installation date. In one embodiment, the installation data specification tool 306 includes a calendar pop-up to allow the customer to select a date. In some embodiments, the user interface 300 may include a terms and conditions listing 309, which lists the terms and conditions that govern the generation of the fitness equipment quote for the customer. The terms and conditions listing 309 may be configured such that the customer is to select an agreement box 312 to indicate that the customer accepts and agrees to the terms and conditions in the terms and conditions listing 309. Once the agreement box 312 is selected, the customer may continue by selecting the continue button 315. The customer may be able to return to the user interface 200 by selecting the previous button 318.

In one embodiment, the selection of data in the user interface 300 continues the process of the quote generation application 115 in narrowing down product lines, manufacturers, etc. for the quote. For example, a particular line of equipment may not be rated for properties having beyond a certain number of units. Selection of a number of units beyond the certain number therefore excludes equipment not rated for the selected number of units.

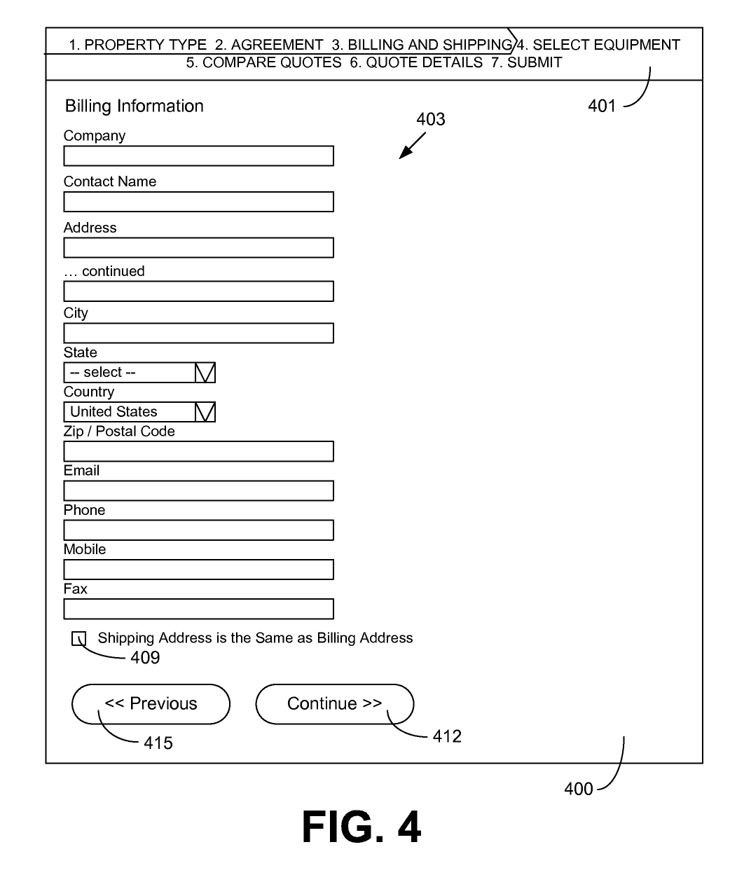

Moving on to FIG. 4, shown is one example of user interface 400 rendered by a browser 145 (FIG. 1) executed in a client 106 (FIG. 1) in the networked environment 100. A status indicator 401 indicates that the “1. PROPERTY TYPE” and the “2. AGREEMENT” tasks have been completed, and that the current task is “3. BILLING AND SHIPPING.” The tasks indicated in the status indicator 401 are provided merely as a non-limiting example of providing task completion information to the customer. In some cases, one or more tasks may be selectable for navigational purposes.

The user interface 400 includes a form 403 for specifying billing information. In some cases, the user interface 400 may also include a form for specifying shipping information. The form 403 is configured to gather various information from the customer such as, for example, property name, company, contact person, email, address, city, country, state, postal code, phone numbers, fax numbers, and/or other information. In some embodiments, various fields of the form 403 may be marked with asterisks, colors, etc. to indicate that the data gathered by the respective fields are required to be provided to continue. In one embodiment, a form for specifying shipping information is hidden by default and is only shown when the check box 409 is deselected.

The check box 409 enables the customer to specify that shipping address is the same as the billing address. In one embodiment, the check box 409 is checked by default. The billing and or shipping information specified through the form 403 may be used to calculate sales tax to be added to a quote. In one embodiment, the postal code and state specified by the customer may be used to calculate sales tax charges. In one embodiment, a real-time sales tax quotation may be obtained from an external service provider. In addition, the postal code and/or state may be used to calculate freight, delivery, installation, and/or other charges. In some cases, the freight and/or other charges may be calculated as a fixed percentage of the total, which may vary, for example, according to equipment manufacturer. A continue button 412 is provided to advance to the next user interface. A previous button 415 may be provided to return to the previous user interface 300 (FIG. 3).

The data gathered by the user interface 400 may be recorded for tracking purposes even if the customer does not complete the quote generation process. When the data is recorded, a notification email or other communication may be sent to the operator. In one embodiment, the data provided in the user interface 400 is cross referenced with one or more other databases to verify its authenticity. For example, a zip code may be verified for a given address. Verification emails or other communications may be sent with one or more codes necessary to continue with the quote generation process. Such measures may be employed to prevent non-authorized users from executing quotes in violation of the terms and conditions established by the operator.

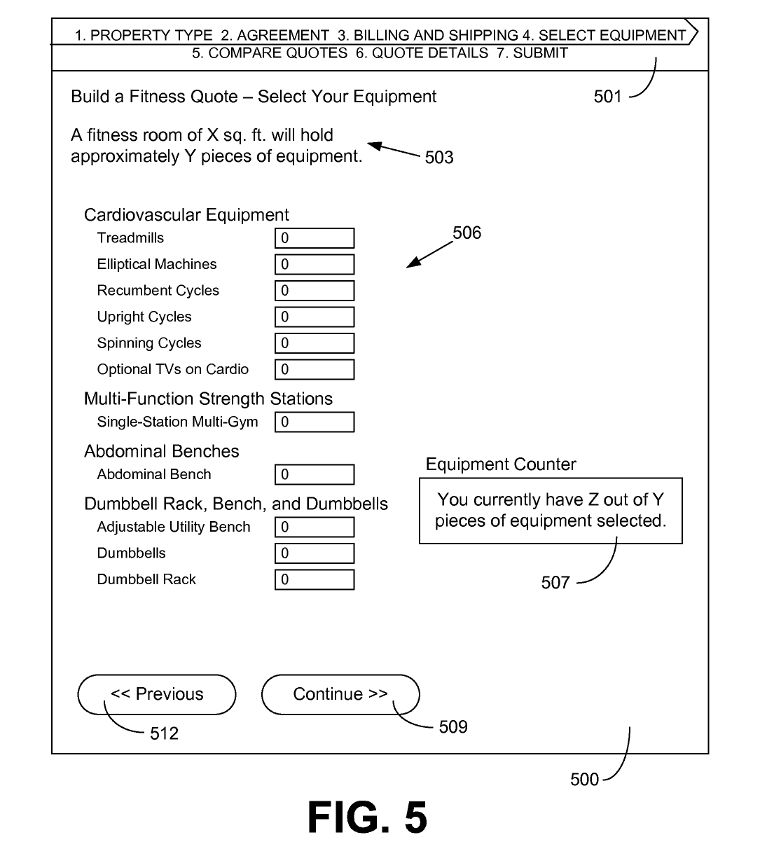

With reference to FIG. 5, shown is one example of a user interface 500 rendered by a browser 145 (FIG. 1) executed in the client 106 (FIG. 1) in the networked environment 100 (FIG. 1). A status indicator 501 indicates that the “1. PROPERTY TYPE,” “2. AGREEMENT,” and “3. BILLING AND SHIPPING” tasks have been completed, and that the current task is “4. SELECT EQUIPMENT.” The tasks indicated in the status indicator 501 are provided merely as a non-limiting example of providing task completion information to the customer. In some cases, one or more tasks may be selectable for navigational purposes.

In this example, the user interface 500 relates to selecting the types of fitness equipment to be included in the fitness room quote. The user interface 500 may include a contents recommendation 503 relating to approximately how many pieces for fitness equipment may be held within a fitness room of the size specified using the fitness room size specification tool 304 (FIG. 3) in the user interface 300 (FIG. 3).

Various input tools 506 may be provided to select different types of equipment. Checkboxes, drop-down boxes, text input boxes, and/or other types of user interface components may be provided to select equipment and indicate quantities. In this example, the various fitness types are grouped into groupings of cardiovascular equipment, multi-function strength stations, abdominal benches, and weight related equipment. In another example, the various fitness types may be grouped into groupings of cardiovascular equipment, stretching equipment, abdominal core equipment, multi-function gyms, dumbbell sets, adjustable utility benches, room accessories/personal fitness, single station strength equipment including equipment for legs, arms, core, and torso, and/or other groupings.

The non-limiting examples of cardio equipment shown in the user interface 500 include, for example, treadmills, elliptical machines, recumbent cycles, upright cycles, spinning cycles, and optional televisions. For multi-function strength stations, the equipment single station multi-gym is shown. For abdominal benches, a single equipment type of abdominal bench is shown. For weight-related equipment, adjustable utility bench, dumbbells, and dumbbell rack are shown. It is understood that the equipment and groupings shown in the user interface 500 are provided merely as an example and many other different types of equipment and groupings may be used in other examples. For example, other equipment may be listed, including a stretch machine, single stations, room accessories, and/or other equipment.

Various numbers of the equipment types may be preselected based upon the information already input by the customer in the user interface 200 (FIG. 2) and the user interface 300 (FIG. 3). In one embodiment, numbers and types of equipment are preselected based at least in part upon the size of the fitness room specified in the user interface 300, the property type, the brand type, the sub brand type, and/or other information input by the customer by the user interface 200 and/or the user interface 300. In some cases, a certain brand or other property classification may prohibit certain types of equipment from being selected. Such prohibited equipment may be non-selectable or omitted from the user interface 500. An equipment counter 507 may be provided to indicate how many of the suggested number of equipment have been selected. A continue button 509 is provided to advance to the next user interface. A previous button 512 may be provided to return to the user interface 400 (FIG. 4).

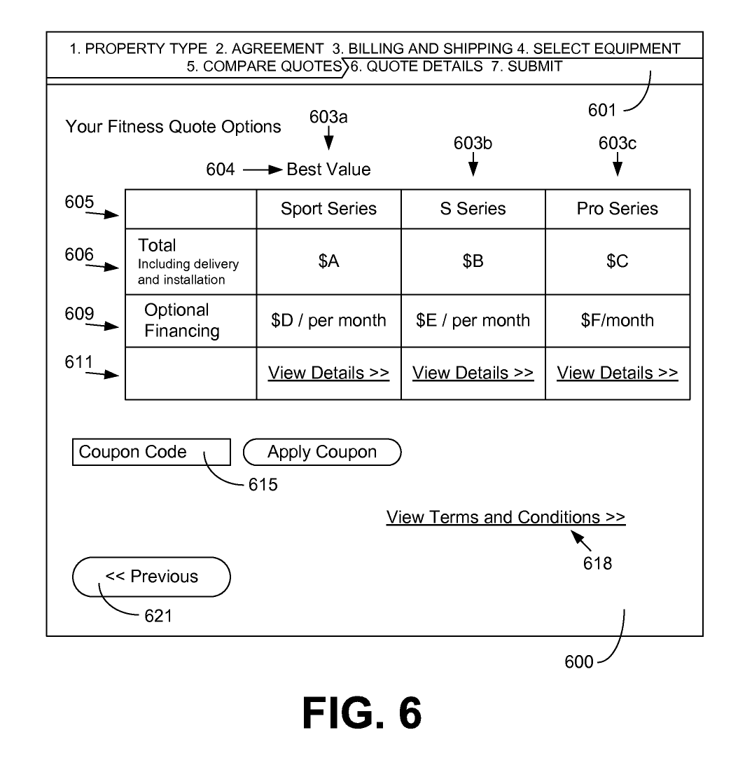

Referring next to FIG. 6, shown is one example of a user interface 600 rendered in a browser 145 (FIG. 1) executed in a client 106 (FIG. 1) in the networked environment 100 (FIG. 1). A status indicator 601 indicates that the “1. PROPERTY TYPE,” “2. AGREEMENT,” “3. BILLING AND SHIPPING,” and “4. SELECT EQUIPMENT” tasks have been completed, and that the current task is “5. COMPARE QUOTES.” The tasks indicated in the status indicator 601 are provided merely as a non-limiting example of providing task completion information to the customer. In some cases, one or more tasks may be selectable for navigational purposes.

Specifically, FIG. 6 relates to a price comparison screen that provides various fitness equipment quote options. The various quotes are generated by the quote generation application 115 (FIG. 1) based upon the information input by the customer through the user interfaces 200 (FIG. 2), 300 (FIG. 3), 400 (FIG. 4), and 500 (FIG. 5). In this example, three quotes 603a, 603b, and 603c are provided. Each of the quotes 603 relates to a different type of equipment provided by the supplier and operator of the quote generation application 115.

One or more of the different quotes 603 may be recommended by the supplier as indicated by the recommendation indicator 604. The recommendation indicator 604 in this example corresponds to a label that states “best value.” A respective equipment line indicator 605 may be provided for each of the quotes 603. In this example, the equipment line indicator 605 shows an equipment classification, e.g., “Sport Series,” “S Series,” and “Pro Series.” The equipment line indicator 605 may correspond to a logo or other graphic associated with the equipment manufacturer. Such logos may be implemented with a roll-over or other mechanism of providing additional descriptive information about the respective manufacturer. In other embodiments, the equipment line indicator 605 may merely be a text label associated with the equipment manufacturer. The total cost 606 to the customer is provided for each of the quotes 603. In addition, a financing cost 609 may be provided for each of the quotes 603. The financing costs 609 in this example relates to a monthly charge for a lease payment. In other examples, the financing cost 609 may relate to a monthly payment for financing the cost for a purchase of the fitness equipment.

A respective detail selection tool 611 is provided for each of the quotes 603 in order to advance to the next user interface screen and view details related to each of the particular quotes. As shown, the user interface 600 may include a coupon specification tool 615 for the customer to enter a coupon code or other discount code that may be used to reduce the total cost of each of the quotes 603. The discount may be applied in dollars, percentage of total price, and/or by other approaches. A terms and conditions link 618 may be provided for the customer to return to the terms and conditions listing 309 (FIG. 3) of the user interface 300 in order to view the terms and conditions associated with the quotes 603.

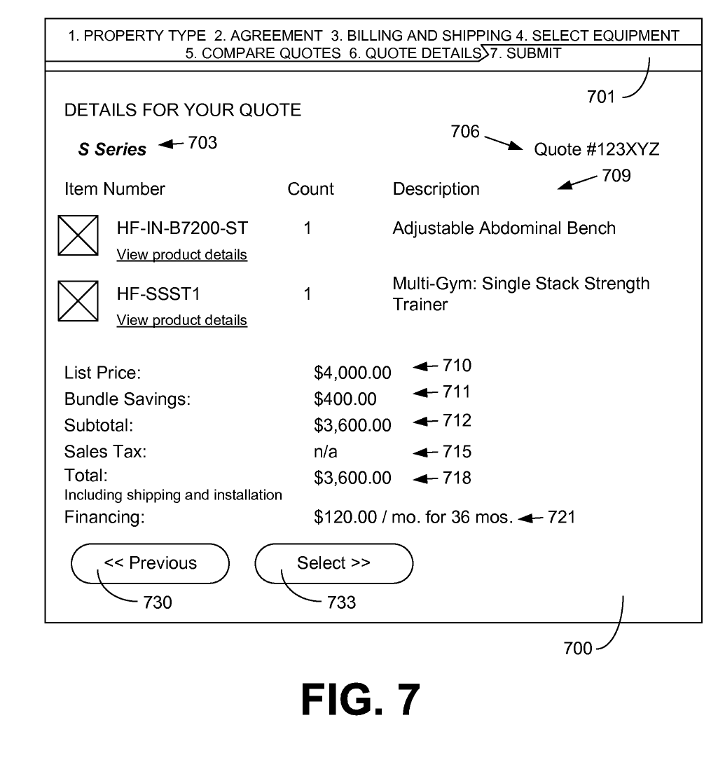

The brands and the items selected as shown in FIG. 6 may be selected based upon a knowledge base, a sorting of a data collection, knowledge, expertise, and know-how. In one embodiment, only those equipment manufacturers approved for the specified property may be displayed. Sales tax may be included in the quotes 603 where applicable and may be determined by the shipping postal code and or state. The total cost 606 shown in the user interface 600 may be the total price including delivery and installation in some cases. A detail selection tool 611 may be provided in conjunction with each of the quotes 603 in order to view the details for each of the quotes for the equipment count and the equipment details as shown in the user interface 500. A previous button 621 may be provided to return to the user interface 500. Selection of one of the detail selection tools 611 will advance to the next user interface, as shown in FIG. 7.

With reference to FIG. 7, shown is a user interface 700 rendered in a browser 145 (FIG. 1) executed in a client 106 (FIG. 1) in the networked environment 100 (FIG. 1). A status indicator 701 indicates that the “1. PROPERTY TYPE,” “2. AGREEMENT,” “3. BILLING AND SHIPPING,” “4. SELECT EQUIPMENT,” and “5. COMPARE QUOTES” tasks have been completed, and that the current task is “6. QUOTE DETAILS.” The tasks indicated in the status indicator 701 are provided merely as a non-limiting example of providing task completion information to the customer. In some cases, one or more tasks may be selectable for navigational purposes.

The user interface 700 provides details for the quote. The user interface 700 may include an equipment line indicator 703 such as a logo or other indicator of the selected equipment manufacturer or line for the quote 603a (FIG. 6). A quote reference number 706 may be provided to uniquely identify the quote 603a that is provided. A listing 709 of the various equipment included within the quote 603a may be provided. The listing 709 may include item numbers, quantities, descriptions, images, and/or other information for each of the equipment items. A link may be provided to view product details for the specific item such as a specification sheet, a detail network page, a portable document format (PDF) detail document, etc.

It is noted that, in this example, no pricing for individual items is shown. That is, only bundle pricing is shown. Individual pricing for the items may be shown in other embodiments if desired. A list price 710 may provide the total price of all of the items before the bundle discount 711 is applied. A bundle discount 711 may be shown to reflect a discount for purchasing multiple items as a bundle. A subtotal 712 may be provided to give the subtotal amount for the equipment costs, delivery, installation, and/or other included charges for the quote 603a. The sales tax 715 may be shown, and the total cost 718 may be shown inclusive of the subtotal 712 and the sales tax 715. A financing cost 721 may be provided to indicate monthly payments for financing either lease or purchase for the equipment. A previous button 730 may be used by the customer to return to the user interface 600 (FIG. 6). A select button 733 may be provided for the user to select the manufacturer or line of equipment associated with the quote 603a to continue with the quote 603a.

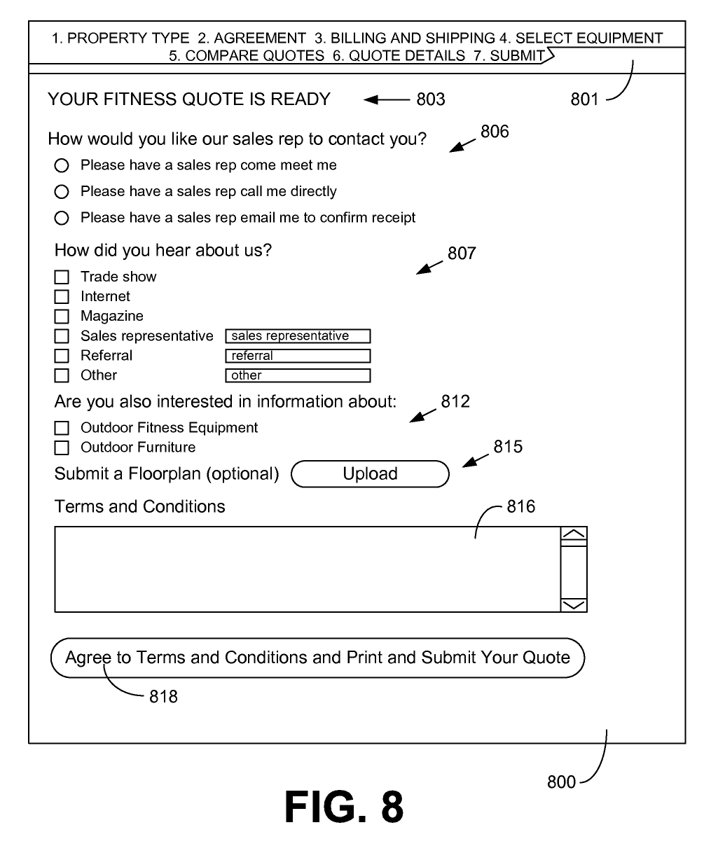

Turning now to FIG. 8, shown is one example of user interface 800 rendered in a browser 145 (FIG. 1) executed in a client 106 (FIG. 1) in the networked environment 100 (FIG. 1). A status indicator 801 indicates that the “1. PROPERTY TYPE,” “2. AGREEMENT,” “3. BILLING AND SHIPPING,” “4. SELECT EQUIPMENT,” “5. COMPARE QUOTES,” and “6. QUOTE DETAILS” tasks have been completed, and that the current task is “7. SUBMIT.” The tasks indicated in the status indicator 801 are provided merely as a non-limiting example of providing task completion information to the customer. In some cases, one or more tasks may be selectable for navigational purposes.

The user interface 800 indicates that the fitness equipment quote is ready and prepared. A heading 803 may, in some cases, indicate the name of the property, the city, the state, and/or other information associated with the quote. A contact preference selection tool 806 may be used by the customer to specify a preferred method of contact for a sales representative. For example, the customer may specify that it is preferred that the sales representative meet the customer, call the customer directly, email the customer to confirm receipt, and/or take another approach. An email preference indication tool may allow the customer to indicate a preference as to whether to receive a copy of the quote by email. A referral selection tool 807 allows the customer to specify how the customer learned about the supplier. Checkboxes or other user interface components may facilitate selection from among, for example, a trade show, the Internet, a magazine, a sales representative, a personal referral, or other. Input boxes may facilitate text entry to further describe, for example, the sales representative, referral, or other source.

An “other interest” specification tool 812 may allow the customer to specify other interests in other types of equipment or subjects. In this non-limiting example, the other interest specification tool 812 allows the user to indicate interests in outdoor fitness equipment, outdoor furniture, and/or other subjects. Floor plan related information 815 may be provided for information regarding preparation of a floor plan for the fitness room. In one embodiment, a customer may be able to upload a floor plan via the user interface 800.

The terms and conditions listing 816 may be configured such that the customer is to select a submission tool 818 to indicate that the customer accepts and agrees to the terms and conditions in the terms and conditions listing 816. The submission tool 818 may be provided in order to submit the quote, print the quote, and/or take another action. Subsequently, the sales team may be alerted by email. In one embodiment, the submission tool 818 is associated only with printing the quote when the user indicates that a quote is not to be emailed or otherwise processed further by the quote generation application 115 (FIG. 1).

In one embodiment, the customer may select a user interface component to initiate and potentially complete a purchase of the fitness equipment indicated by the quote. For example, the user interfaces 800 or 700 may include a check-out button, a finalize purchase button, or other types of user interface components. As part of the customer completing a purchase electronically, the customer may provide a payment instrument electronically, the customer may be invoiced at a later time (e.g., cash on delivery, etc.), and so on.

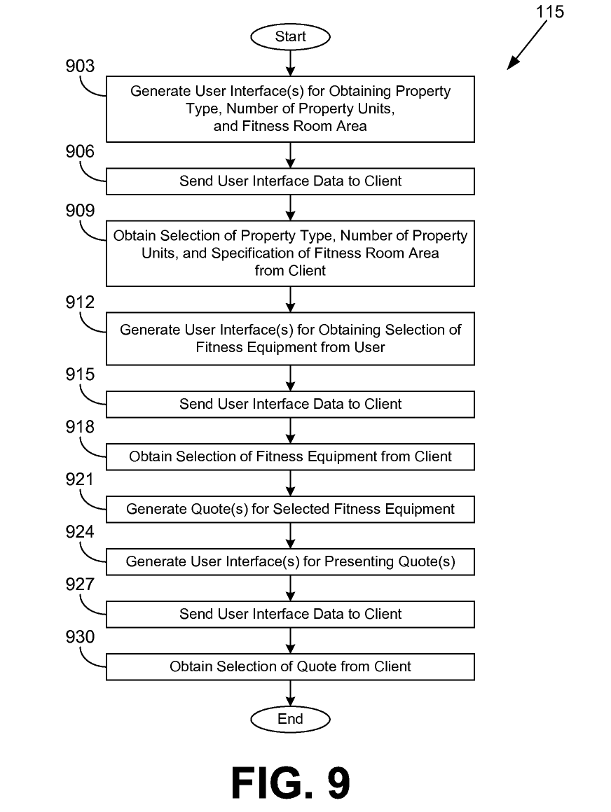

Referring next to FIG. 9, shown is a flowchart that provides one example of the operation of a portion of the quote generation application 115 according to various embodiments. It is understood that the flowchart of FIG. 9 provides merely an example of the many different types of functional arrangements that may be employed to implement the operation of the portion of the quote generation application 115 as described herein. As an alternative, the flowchart of FIG. 9 may be viewed as depicting an example of steps of a method implemented in the computing device 103 (FIG. 1) according to one or more embodiments.

Beginning with box 903, the quote generation application 115 generates one or more user interfaces for obtaining a property type (e.g., including property brand and sub-brand), a number of property units, and a specification of a fitness room size or area. Additionally, the user interfaces may obtain and, optionally, verify, contact information for a user. The user interfaces may correspond to the user interface 200 (FIG. 2), the user interface 300 (FIG. 3), the user interface 400 (FIG. 4), or additional or fewer user interfaces. The user interfaces may correspond to network pages, mobile application screens, etc. In box 906, the user interface data is sent to the client 106 (FIG. 1) over the network 109 (FIG. 1).

In box 909, the quote generation application 115 obtains the selection of a property type, the number of property units (e.g., rooms, apartments, etc.), and the specification of the fitness room area or size from the client 106. Further, the quote generation application 115 may obtain, verify, and record contact information from the user at the client 106. In some cases, the quote generation application 115 may obtain a desired installation date and a description of the project (e.g., new installation, remodel or renovation, just a few selected pieces, etc.). The quote generation application 115 may also obtain assent to various terms and conditions as desired.

In box 912, the quote generation application 115 generates one or more user interfaces for obtaining a selection of fitness equipment from the user. For example, the user interface(s) may correspond to the user interface 500 (FIG. 5). The user interfaces may include a form for specifying a respective quantity for each of multiple different types of fitness equipment. In some cases, the quote generation application 115 may determine a recommended quantity of fitness equipment based at least in part on the fitness room size, and the user interface may be configured to render a comparison of a currently selected quantity of fitness equipment with the recommended quantity of fitness equipment.

The user interface may be preconfigured based at least in part on the property type, the number of property units, and the fitness room size. In one non-limiting example, fitness equipment may be preselected in the user interface based at least in part on a property brand corresponding to the property type. The user interface may include a form for obtaining an approved subset of fitness equipment, where the form is pre-populated with a recommended subset of fitness equipment determined based at least in part on the property type and the area of the fitness room.

In box 915, the quote generation application 115 sends the user interface data to the client 106 by way of the network 109. In box 918, the quote generation application 115 obtains a selection of fitness equipment from the client 106 by way of the network 109. In box 921, the quote generation application 115 automatically generates one or more quotes for the selected fitness equipment. In one embodiment, the quote generation application 115 may be configured to generate multiple quotes, where each of the quotes corresponds to a particular line of equipment. The particular lines of equipment or manufacturers may be determined for use in preparing the quote based at least in part on the property type and/or the property size.

In box 924, the quote generation application 115 generates one or more user interfaces for presenting the quote(s). The user interfaces may correspond, for example, to the user interface 600 (FIG. 6). The user interface may present a financing estimate for each of the quotes. In box 927, the user interface data is sent to the client 106 by way of the network 109. In box 930, the quote generation application 115 obtains a selection of one of the quotes from the client 106 by way of the network 109. The quote generation application 115 may subsequently generate further user interfaces (e.g., user interfaces 700 (FIG. 7) and 800 (FIG. 8)) to present further detail regarding the selected quote. The quote generation application 115 may also obtain a floor plan from the user, as well as preferred contact information, referral information, and so on. Thereafter, the portion of the quote generation application 115 ends.

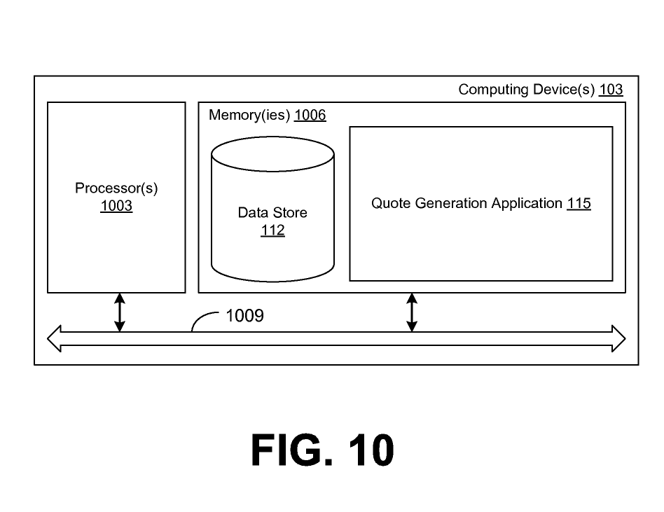

With reference to FIG. 10, shown is a schematic block diagram of the computing device 103 according to an embodiment of the present disclosure. The computing device 103 includes at least one processor circuit, for example, having a processor 1003 and a memory 1006, both of which are coupled to a local interface 1009. To this end, the computing device 103 may comprise, for example, at least one server computer or like device. The local interface 1009 may comprise, for example, a data bus with an accompanying address/control bus or other bus structure as can be appreciated.

Stored in the memory 1006 are both data and several components that are executable by the processor 1003. In particular, stored in the memory 1006 and executable by the processor 1003 are the quote generation application 115 and potentially other applications. Also stored in the memory 1006 may be a data store 112 and other data. In addition, an operating system may be stored in the memory 1006 and executable by the processor 1003.

It is understood that there may be other applications that are stored in the memory 1006 and are executable by the processors 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, performing load balancing. The processor 1003 may be of electrical or of some other available construction.

Although the quote generation application 115 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 9 shows the functionality and operation of an implementation of portions of the quote generation application 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003 in a computer system or other system. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the quote generation application 115, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method, comprising the steps of:
generating, in at least one computing device, a first network page that includes a first form for requesting at least one quote for a fitness equipment installation, the first form being configured to obtain a property type and an area of a fitness room;
sending, in the at least one computing device, the first network page to a client;
obtaining, in the at least one computing device, the property type and the area of the fitness room from the client;
determining, in the at least one computing device, a recommended subset of fitness equipment based at least in part on the property type and the area of the fitness room;
generating, in the at least one computing device, a second network page that includes a second form for obtaining an approved subset of fitness equipment, the second form being pre-populated with the recommended subset of fitness equipment;
sending, in the at least one computing device, the second network page to the client;
obtaining, in the at least one computing device, the approved subset of fitness equipment from the client;
determining, in the at least one computing device, at least one fitness equipment quote based at least in part on the approved subset of fitness equipment and the property type, wherein a manufacturer for the corresponding at least one fitness equipment quote is determined based at least in part on the property type;
generating, in the at least one computing device, a third network page that presents the at least one fitness equipment quote; and
sending, in the at least one computing device, the third network page to the client.

2. A system, comprising:
at least one computing device; and
a quote generation application executable in the at least one computing device, the quote generation application comprising:
logic that obtains a selection of a property type, a number of property units, and a specification of a fitness room size from a user;
logic that generates a first user interface for obtaining a selection of fitness equipment from the user;
logic that obtains the selection of fitness equipment from the user via the first user interface;
logic that automatically generates a quote for providing fitness equipment to the user, the quote being based at least in part on the selection of fitness equipment, the fitness room size, the number of property units, and the property type; and
logic that generates a second user interface for presenting the quote.

3. The system of claim 2, wherein the second user interface includes at least one component for initiating an electronic purchase of fitness equipment according to the quote.

4. The system of claim 2, wherein the quote generation application further comprises logic that obtains a floor plan from the user.

5. The system of claim 2, wherein the quote generation application further comprises logic that generates at least one user interface for obtaining the selection of the property type, the number of property units, and the specification of the fitness room size from the user.

6. The system of claim 2, wherein the first user interface includes a form for specifying a respective quantity for each a plurality of different types of fitness equipment, and the first user interface excludes manufacturer information.

7. The system of claim 2, wherein the quote generation application further comprises logic that determines a particular line of fitness equipment to be used in preparing the quote based at least in part on the property type.

8. The system of claim 2, wherein the quote generation application further comprises logic that determines a particular line of fitness equipment to be used in preparing the quote based at least in part on the number of property units.

9. The system of claim 2, wherein the quote generation application further comprises logic that determines a recommended quantity of fitness equipment based at least in part on the fitness room size.

10. The system of claim 9, wherein the first user interface is configured to render a comparison of a currently selected quantity of fitness equipment with the recommended quantity of fitness equipment.

11. The system of claim 2, wherein the quote generation application further comprises logic that preconfigures the first user interface based at least in part on the property type, the number of property units, and the fitness room size.

12. The system of claim 2, wherein the quote generation application further comprises logic that preselects the selection of fitness equipment in the first user interface based at least in part on a property brand corresponding to the property type.

13. The system of claim 2, wherein the quote generation application further comprises logic that obtains and records contact information from the user before presenting the quote to the user.

14. The system of claim 2, wherein the quote includes a financing estimate.

15. The system of claim 2, wherein the logic that automatically generates the quote is configured to generate a plurality of quotes, each of the quotes corresponding to a particular line of equipment.

16. The system of claim 2, wherein the property type comprises a property brand and a property sub-brand.

17. A non-transitory computer-readable medium embodying a program executable in a computing device, comprising:
code that obtains a selection of a property type, a number of property units, and a specification of a fitness room size from a user;
code that generates a first user interface for obtaining a selection of fitness equipment from the user;
code that obtains the selection of fitness equipment from the user via the first user interface;
code that automatically generates a quote for providing fitness equipment to the user, the quote being based at least in part on the selection of fitness equipment, the fitness room size, the number of property units, and the property type; and
code that generates a second user interface for presenting the quote.

18. The non-transitory computer-readable medium of claim 17, wherein the code that automatically generates the quote is configured to generate a plurality of quotes, each of the quotes corresponding to a particular line of equipment.

19. The non-transitory computer-readable medium of claim 17, further comprising code that preconfigures the first user interface based at least in part on the property type, the number of property units, and the fitness room size.

20. The non-transitory computer-readable medium of claim 17, further comprising code that obtains and records contact information from the user before presenting the quote to the user.
